(19) United States
(12) Patent Application Publication
(10) Pub. No.: US 2026/0268308 A1
(43) Pub. Date: Sep. 10, 2026

(54) Non-Custodial Automated Transfers of Digital Assets from a Decentralized Cryptographic Wallet

(71) Applicant: SPIRIT TECHNOLOGIES INC., Brooklyn, NY (US)

(72) Inventor: Yehuda Kirsh, Brooklyn, NY (US)

(21) Appl. No.: 19/661,492

(22) Filed: Apr. 28, 2026

Related U.S. Application Data
(63) Continuation-in-part of application No. 18/444,584, filed on Feb. 16, 2024, now Pat. No. 12,614,161.
(60) Provisional application No. 63/485,515, filed on Feb. 16, 2023.

(51) Int. Cl. G06Q 20/36; G06Q 20/38; G06Q 20/40

(52) U.S. Cl. CPC G06Q 20/3674; G06Q 20/3825; G06Q 20/405

(57) ABSTRACT

Automatic and/or recurring transfers are a fundamental component of modern financial systems, yet they remain difficult to implement securely within blockchain environments. Existing approaches either require users to repeatedly authorize commands or rely on delegated spending mechanisms that introduce security risks. The disclosed system supports recurring and/or automatic transfers triggered by temporal or conditional events based on pre-signed command pools indexed across wide nonce ranges. By leveraging the deterministic ordering of commands in Ethereum Virtual Machine-based systems, the system enables automated transfer execution without granting third-party control over user assets or funds and without requiring continuous user interaction.

### RELATED APPLICATIONS

The subject matter of this application is related to U.S. Utility patent application Ser. No. 18/444,584, now U.S. Pat. No. 12,614,161, filed on 2024 Feb. 16 and U.S. Provisional Application No. 63/485,515, filed on 2023 Feb. 16, all of which applications are hereby incorporated by reference.

### BACKGROUND OF THE INVENTION

Blockchain systems are built around a strict ownership model in which only the holder of a private key can authorize commands. This design provides strong guarantees of security and self-custody, but it also limits the ability to replicate common financial behaviors such as automated transfers. In traditional financial systems, these automated transfers are enabled by delegating authority to trusted intermediaries that can initiate commands on behalf of the user. In decentralized systems, such delegation contradicts the foundational principle that control over funds or assets must remain exclusively with the user.

The simplest way to perform recurring transfers on a blockchain is for the user to manually sign each command when it becomes due. While this approach maintains security, it is inherently inefficient and unreliable. It assumes that the user is always available and willing to authorize transfers in real time, which is incompatible with many real-world use cases such as subscriptions, payroll, or scheduled obligations.

To overcome this limitation, many systems rely on smart contracts or delegated approvals. In these models, the user grants a contract permission to spend tokens on their behalf, often through mechanisms such as token allowances. Although this enables automation, it introduces persistent permissions that extend beyond a single command. These permissions significantly increase the attack surface, as vulnerabilities in the contract or its integrations can lead to unauthorized fund transfers. In practice, this has resulted in numerous exploits where users' funds or assets were drained due to overly broad or compromised approvals.

The core issue is that current approaches force a tradeoff between usability and security. Users must either sacrifice convenience or accept additional risk. A solution is needed that allows automated transfers—whether recurring (temporal) or event-triggered (conditional)—to be executed predictably without requiring ongoing trust or exposure.

### SUMMARY OF THE INVENTION

A method, which can be performed by one or more computer systems, includes: identifying a source cryptographic wallet, the source wallet being associated with a blockchain and having a current nonce that increments with each subsequent command; identifying a target cryptographic wallet into which digital assets can be transferred from the source cryptographic wallet at a future date; creating a consecutive sequence of a plurality of future nonces, wherein a smallest of the future nonces is greater than the current nonce; identifying a set of one or more amounts of digital assets storeable in the source wallet; generating and storing a plurality of signed commands by, for each nonce of the consecutive sequence of future nonces in combination with and in turn for each amount of the set of one or more amounts of digital assets: generating a signed command to transfer the each amount from the source wallet to the target wallet, the signed command having the each nonce and the each amount; and storing the signed command without publishing the command to the blockchain; and subsequent to the generating and storing the plurality of signed commands and in response to a trigger condition having been satisfied: determining a new current nonce for the source wallet; identifying an amount of digital assets to be transferred; selecting from the stored signed commands a proper subset of the plurality of stored and signed commands having a set of sequential nonces starting at one greater than the new current nonce and having a sum total value substantially equal to the amount of digital assets to be transferred; and publishing the selected signed commands to the blockchain.

The method can include further in response to the trigger condition having been satisfied, determining that the source wallet contains a digital asset balance at least as great as the amount of digital assets to be transferred.

The source cryptographic wallet can have an owner, and the trigger condition can be based on at least one of: an expiration of a timer set or authorized by the owner, a defined date or time set or authorized by the owner having been reached, a recurring periodic duration set or authorized by the owner having elapsed, a recurring or periodic transaction authorized by the owner having occurred, an asset price threshold having reached a predefined level set by the owner, and the owner having become deceased.

The trigger condition can be based on an action of an automated artificial intelligence agent acting on behalf of an owner of the source cryptographic wallet.

The set of one or more amounts of digital assets can consist of between 1 and 10 different amounts.

The set of one or more amounts of digital assets can consist of between 2 and 8 different amounts.

The set of one or more amounts of digital assets can consist of between 4 and 6 different amounts.

A method, which can be performed by one or more computer systems, includes: identifying a source cryptographic wallet, the source wallet being associated with a blockchain and having a current nonce; identifying a target cryptographic wallet into which digital assets can be transferred from the source cryptographic wallet at a future date; creating a plurality of future nonces; identifying a set of one or more amounts of digital assets storeable in the source wallet; generating and storing a plurality of signed commands by, for each nonce of the plurality of future nonces in combination with and in turn for each amount of the set of one or more amounts of digital assets: generating a signed command to transfer the each amount from the source wallet to the target wallet, the signed command having the each nonce and the each amount; and storing the signed command without publishing the command to the blockchain; and subsequent to the generating and storing the plurality of signed commands and in response to a trigger condition having been satisfied: determining a new current nonce for the source wallet; identifying an amount of digital assets to be transferred; selecting from the stored signed commands a proper subset of the plurality of stored and signed commands having a sum total value substantially equal to the amount of digital assets to be transferred; and publishing the selected signed commands to the blockchain.

The method can include further in response to the trigger condition having been satisfied, determining that the source wallet contains a digital asset balance at least as great as the amount of digital assets to be transferred.

The source cryptographic wallet can have an owner, and the trigger condition can be based on at least one of: an expiration of a timer set or authorized by the owner, a defined date or time set or authorized by the owner having been reached, a recurring periodic duration set or authorized by the owner having elapsed, a recurring or periodic transaction authorized by the owner having occurred, an asset price threshold having reached a predefined level set by the owner, and the owner having become deceased.

The trigger condition can be based on an action of an automated artificial intelligence agent acting on behalf of an owner of the source cryptographic wallet.

The set of one or more amounts of digital assets can consist of between 1 and 10 different amounts.

The set of one or more amounts of digital assets can consist of between 2 and 8 different amounts.

The set of one or more amounts of digital assets can consist of between 4 and 6 different amounts.

The plurality of future nonces can be a consecutive sequence, wherein a smallest of the plurality of future nonces is greater than the current nonce, and wherein the proper subset of the plurality of stored and signed commands further have a set of sequential nonces starting at one greater than the new current nonce.

A set of one or more computer systems can perform the method.

A non-transitory computer readable medium having instructions stored thereon, wherein the instructions are executed by the one or more computer systems and cause the one or more computer systems to perform the method.

As will be appreciated by one skilled in the art, multiple aspects described in this summary can be variously combined in different operable embodiments. All such operable combinations, though they may not be explicitly set forth in the interest of efficiency, are specifically contemplated by this disclosure.

### BRIEF DESCRIPTION OF THE DRAWINGS

FIG. 1 illustrates a general computer architecture 100 that can be appropriately configured to implement components disclosed in accordance with various embodiments.

### DETAILED DESCRIPTION

In the following description, references are made to various embodiments in accordance with which the disclosed subject matter can be practiced. Some embodiments may be described using the expressions one/an/another embodiment or the like, multiple instances of which do not necessarily refer to the same embodiment. Particular features, structures or characteristics associated with such instances can be combined in any suitable manner in various embodiments unless otherwise noted. By way of example, this disclosure may set out a set or list of a number of options or possibilities for an embodiment, and in such case, this disclosure specifically contemplates all clearly feasible combinations and/or permutations of items in the set or list.

### Overview

The present disclosure addresses a structural gap in the prior art implementations of automated transfers on blockchain cryptocurrency systems. Users need automation for practical usability, but existing solutions either compromise security or impose ongoing operational friction. The present disclosure resolves this tension by introducing a mechanism that preserves explicit user authorization while enabling future commands to be executed without additional interaction.

A new protocol leverages pre-authorized commands. Instead of granting a third party the ability to initiate transfers, the user creates a large set of commands in advance, signs them locally, and makes them available for future execution. Each command is complete and valid at the time of signing but is not immediately broadcast to the network.

These commands are constructed with fixed parameters, including the recipient address, transfer amount, and a specific nonce. Once signed, they cannot be modified. At a later time, an external actor such as a service provider or automated system can submit one of these commands to the blockchain, where it will be processed as if the user had just signed and sent it.

One distinction in this model is that authorization can be finite and explicit. Rather than granting open-ended access, the user can define a bounded set of allowable transfers.

### Nonce-Based Execution Model

The protocol leverages the behavior of nonces in Ethereum Virtual Machine (EVM) based blockchains. Each account maintains a nonce that increments with every command. The network enforces strict sequencing, meaning that a command is only valid if its nonce matches the next expected value for that account. Commands cannot be executed out of order, nor can multiple commands share the same nonce.

At the time of setup, the protocol observes the current nonce of the user's wallet and generates a large number of commands with sequential nonces extending far into the future. Rather than creating a simple linear schedule tied to specific dates, the system produces a broad pool of commands covering a wide nonce range. This design choice is essential because it allows the user to continue interacting with their wallet normally after the commands are created.

As the user performs unrelated commands, their wallet nonce advances in ways that cannot be predicted in advance. However, because the pre-signed command pool spans a sufficiently large range, there will always exist a command whose nonce matches the next valid value required by the network.

When a transfer is due, the executing party queries the current nonce of the user's wallet and determines the next required nonce. It then selects the pre-signed command corresponding to that nonce and submits it to the network. The blockchain validates the signature and nonce, and the command is executed in the usual manner. This process can repeat indefinitely as long as unused commands remain within the valid nonce range.

To illustrate the mechanics, consider the following example scenario.

### Initial Setup

User wallet current nonce: 100
Monthly transfer obligation: 1 USDC to a service provider
Desired coverage: long-term (e.g., multiple years without regeneration)
   The system generates a large pool of pre-signed commands:
~2,000 commands
Each transferring 1 USDC
Nonces ranging from 101 to 2100
All commands signed by the user
All commands locked to the service provider's wallet
   The user stores this command set and continues using their wallet normally. The wallet nonce increases unpredictably for example after some time: current nonce=347

### Transfer Execution (At transfer Time)

When a monthly transfer is due:
The service provider queries the blockchain and reads:
   Current wallet nonce=347
The next valid nonce must be: 348
The provider retrieves from the command pool:
   The pre-signed command with nonce 348
   Amount: 1 USDC
   Recipient: service provider
The provider broadcasts this command
The blockchain validates and executes it:
   Wallet nonce becomes 348
   transfer is completed

### Subsequent Transfers

At the next transfer cycle, the same process repeats, continuing seamlessly regardless of how the user uses their wallet in between.

In addition, the same method may be applied to conditional transfers where the trigger is not the passage of time, but rather a specific event or external criterion, such as an asset reaching a target price or a specified trading volume being met while maintaining the same non-custodial security profile.

### Security Properties

The protocol maintains a strong security posture by eliminating persistent permissions entirely. No contract or third party is ever granted the ability to spend assets arbitrarily. Each command represents a single, discrete authorization that can only be used once and only in the exact form defined by the user.

Because command parameters are fixed at signing time, there is no possibility of modification. The recipient address and amount are immutable, ensuring that even if the command data is exposed, it cannot be redirected or altered. The maximum possible exposure is therefore limited to the total value encoded in the unused commands.

Control can remain fully with the user at all times, but this control can be exercised through the underlying constraints of nonce range and available balance rather than an explicit cancellation mechanism. The pre-signed command pool can be bounded both by a finite nonce range and by the assets present in the wallet. The user can therefore terminate or limit future transfers in two straightforward ways. First, by continuing to use the wallet and advancing the nonce beyond the highest nonce covered by the pre-signed command pool, the user ensures that no further pre-signed commands remain valid for execution.

Second, by removing or reducing the relevant assets from the wallet, the user can prevent subsequent commands from being successfully executed due to insufficient balance. This is directly analogous to recurring transfers in traditional financial systems, where a scheduled charge may fail if a credit card is declined or if there are insufficient funds in a bank account. As such, this should not be viewed as a limitation of the model, but rather as a natural and expected property of any automated transfer system in which the user retains full control over their funds or assets.

In all cases, the effect is immediate at the protocol level and does not require coordination with any external system or service provider.

### Reliability and Practical Considerations

The use of large nonce ranges provides resilience against unpredictable wallet activity. Even if the user executes a significant number of independent commands, the system can continue to function as long as the current nonce remains within the pre-signed range. To maintain continuity over time, users can periodically generate new command pools that extend coverage further into the future.

Additional flexibility can be introduced by generating commands with varying denominations, allowing for more granular transfer composition if needed. However, the core system does not depend on such variations and remains effective with uniform command amounts.

Storage of pre-signed commands can be handled in multiple ways, including local storage, encrypted cloud systems, or dedicated infrastructure. Execution requires only access to the signed command data and does not depend on any privileged system components.

Agentic AI refers to autonomous systems that can perceive, reason, and act independently to achieve complex goals, going beyond simple chat to execute multi-step tasks with minimal human supervision. These AI agents utilize LLMs for understanding and interact with external tools, APIs, and databases. In some embodiments, the owner of a wallet can instruct and/or authorize an Agentic AI agent to perform and/or initiate transfers on behalf of the owner.

### Computer Implementation

Components of the embodiments disclosed herein, which may be referred to as methods, processes, applications, programs, modules, engines, functions or the like, can be implemented by configuring one or more computers or computer systems using special purpose software embodied as instructions on a non-transitory computer readable medium. The one or more computers or computer systems can be or include one or more standalone, client and/or server computers, which can be optionally networked through wired and/or wireless networks as a networked computer system.

The special purpose software can include one or more instances thereof, each of which can include, for example, one or more of client software, server software, desktop application software, app software, database software, operating system software, and driver software. Client software can be configured to operate a system as a client that sends requests for and receives information from one or more servers and/or databases. Server software can be configured to operate a system as one or more servers that receive requests for and send information to one or more clients. Desktop application software and/or app software can operate a desktop application or app on desktop and/or portable computers. Database software can be configured to operate one or more databases on a system to store data and/or information and respond to requests by client software to retrieve, store, and/or update data. Operating system software and driver software can be configured to provide an operating system as a platform and/or drivers as interfaces to hardware or processes for use by other software of a computer or computer system. By way of example, any data created, used or operated upon by the embodiments disclosed herein can be stored in, accessed from, and/or modified in a database operating on a computer system.

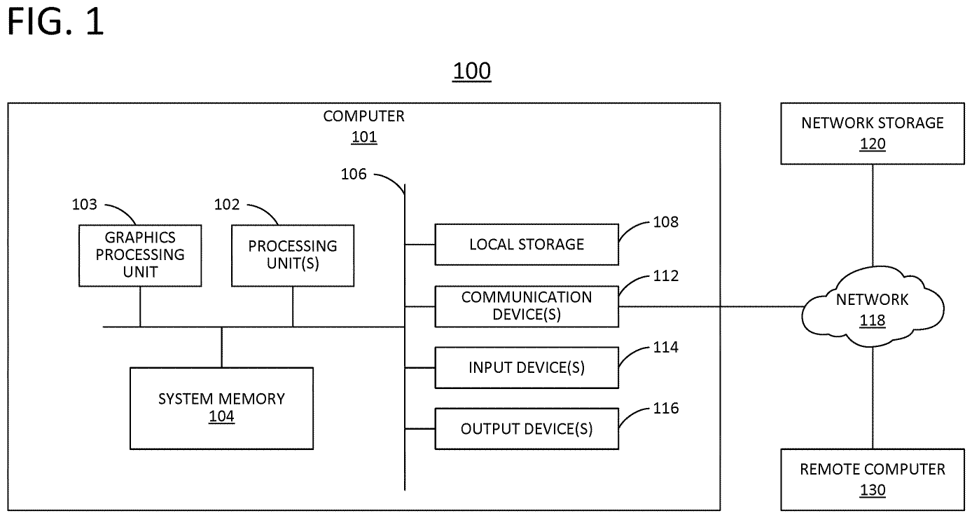

FIG. 1 illustrates a general computer architecture 100 that can be appropriately configured to implement components disclosed in accordance with various embodiments. The computing architecture 100 can include various common computing elements, such as a computer 101, a network 118, and one or more remote computers 130. The embodiments disclosed herein, however, are not limited to implementation by the general computing architecture 100.

Referring to FIG. 1, the computer 101 can be any of a variety of general purpose computers such as, for example, a server, a desktop computer, a laptop computer, a tablet computer or a mobile computing device. The computer 101 can include a processing unit 102, a system memory 104 and a system bus 106.

The processing unit 102 can be or include one or more of any of various commercially available computer processors, which can each include one or more processing cores that can operate independently of each other. Additional co-processing units, such as a graphics processing unit 103, also can be present in the computer.

The system memory 104 can include volatile devices, such as dynamic random access memory (DRAM) or other random access memory devices. The system memory 104 can also or alternatively include non-volatile devices, such as a read-only memory or flash memory.

The computer 101 can include local non-volatile secondary storage 108 such as a disk drive, solid state disk, or removable memory card. The local storage 108 can include one or more removable and/or non-removable storage units. The local storage 108 can be used to store an operating system that initiates and manages various applications that execute on the computer. The local storage 108 can also be used to store special purpose software configured to implement the components of the embodiments disclosed herein and that can be executed as one or more applications under the operating system.

The computer 101 can also include communication device(s) 112 through which the computer communicates with other devices, such as one or more remote computers 130, over wired and/or wireless computer networks 118. Communications device(s) 112 can include, for example, a network interface for communicating data over a wired computer network. The communication device(s) 112 can include, for example, one or more radio transmitters for communications over Wi-Fi, Bluetooth, and/or mobile telephone networks.

The computer 101 can also access network storage 120 through the computer network 118. The network storage can include, for example, a network attached storage device located on a local network, or cloud-based storage hosted at one or more remote data centers. The operating system and/or special purpose software can alternatively be stored in the network storage 120.

The computer 101 can have various input device(s) 114 such as a keyboard, mouse, touchscreen, camera, microphone, accelerometer, thermometer, magnetometer, or any other sensor. Output device(s) 116 such as a display, speakers, printer, or eccentric rotating mass vibration motor can also be included.

The various storage 108, communication device(s) 112, output devices 116 and input devices 114 can be integrated within a housing of the computer, or can be connected through various input/output interface devices on the computer, in which case the reference numbers 108, 112, 114 and 116 can indicate either the interface for connection to a device or the device itself as the case may be.

Any of the foregoing aspects may be embodied in one or more instances as a computer system, as a process performed by such a computer system, as any individual component of such a computer system, or as an article of manufacture including computer storage in which computer program instructions are stored and which, when processed by one or more computers, configure the one or more computers to provide such a computer system or any individual component of such a computer system. A server, computer server, a host or a client device can each be embodied as a computer or a computer system. A computer system may be practiced in distributed computing environments where operations are performed by multiple computers that are linked through a communications network. In a distributed computing environment, computer programs can be located in both local and remote computer storage media.

Each component of a computer system such as described herein, and which operates on one or more computers, can be implemented using the one or more processing units of the computer and one or more computer programs processed by the one or more processing units. A computer program includes computer-executable instructions and/or computer-interpreted instructions, such as program modules, which instructions are processed by one or more processing units in the computer. Generally, such instructions define routines, programs, objects, components, data structures, and so on, that, when processed by a processing unit, instruct the processing unit to perform operations on data or configure the processor or computer to implement various components or data structures.

Components of the embodiments disclosed herein, which may be referred to as modules, engines, processes, functions or the like, can be implemented in hardware, such as by using special purpose hardware logic components, by configuring general purpose computing resources using special purpose software, or by a combination of special purpose hardware and configured general purpose computing resources. Illustrative types of hardware logic components that can be used include, for example, Field-programmable Gate Arrays (FPGAs), Application-specific Integrated Circuits (ASICs), Application-specific Standard Products (ASSPs), System-on-a-chip systems (SOCs), and Complex Programmable Logic Devices (CPLDs).

### Conclusion

The disclosed protocol introduces a new approach to recurring transfers in blockchain systems by leveraging pre-signed commands and nonce-based sequencing. This model eliminates the need for delegated authority while preserving the ability to automate future transfers. By aligning with the underlying mechanics of EVM command processing, it achieves a balance between usability and security that existing solutions fail to provide.

In doing so, it establishes a practical foundation for enabling real-world financial behaviors—such as subscriptions, payroll, and scheduled transfers—within a fully self-custodial environment.

Although the subject matter has been described in terms of certain embodiments, other embodiments that may or may not provide various features and aspects set forth herein shall be understood to be contemplated by this disclosure. The specific embodiments set forth herein are disclosed as examples only, and the scope of the patented subject matter is defined by the claims that follow.

1. A method performed by one or more computer systems, the method comprising, the one or more computer systems:
identifying a source cryptographic wallet, the source wallet being associated with a blockchain and having a current nonce that increments with each subsequent command;
identifying a target cryptographic wallet into which digital assets can be transferred from the source cryptographic wallet at a future date;
creating a consecutive sequence of a plurality of future nonces, wherein a smallest of the future nonces is greater than the current nonce;
identifying a set of one or more amounts of digital assets storeable in the source wallet;
generating and storing a plurality of signed commands by, for each nonce of the consecutive sequence of future nonces in combination with and in turn for each amount of the set of one or more amounts of digital assets:
generating a signed command to transfer the each amount from the source wallet to the target wallet, the signed command having the each nonce and the each amount; and
storing the signed command without publishing the command to the blockchain; and
subsequent to the generating and storing the plurality of signed commands and in response to a trigger condition having been satisfied:
determining a new current nonce for the source wallet;
identifying an amount of digital assets to be transferred;
selecting from the stored signed commands a proper subset of the plurality of stored and signed commands having a set of sequential nonces starting at one greater than the new current nonce and having a sum total value substantially equal to the amount of digital assets to be transferred; and
publishing the selected signed commands to the blockchain.

2. The method of claim 1, further comprising, further in response to the trigger condition having been satisfied:
determining that the source wallet contains a digital asset balance at least as great as the amount of digital assets to be transferred.

3. The method of claim 1, wherein the source cryptographic wallet has an owner, and wherein the trigger condition is based on at least one of:
an expiration of a timer set or authorized by the owner,
a defined date or time set or authorized by the owner having been reached,
a recurring periodic duration set or authorized by the owner having elapsed,
a recurring or periodic transaction authorized by the owner having occurred,
an asset price threshold having reached a predefined level set by the owner, and
the owner having become deceased.

4. The method of claim 1, wherein the trigger condition is based on an action of an automated artificial intelligence agent acting on behalf of an owner of the source cryptographic wallet.

5. The method of claim 1, wherein the set of one or more amounts of digital assets consists of between 1 and 10 different amounts.

6. The method of claim 1, wherein the set of one or more amounts of digital assets consists of between 2 and 8 different amounts.

7. The method of claim 1, wherein the set of one or more amounts of digital assets consists of between 4 and 6 different amounts.

8. A set of one or more computer systems that perform the method of claim 1.

9. A non-transitory computer readable medium having instructions stored thereon, wherein the instructions are executed by the one or more computer systems and cause the one or more computer systems to perform the method of claim 1.

10. A method performed by one or more computer systems, the method comprising, the one or more computer systems:
identifying a source cryptographic wallet, the source wallet being associated with a blockchain and having a current nonce;
identifying a target cryptographic wallet into which digital assets can be transferred from the source cryptographic wallet at a future date;
creating a plurality of future nonces;
identifying a set of one or more amounts of digital assets storeable in the source wallet;
generating and storing a plurality of signed commands by, for each nonce of the plurality of future nonces in combination with and in turn for each amount of the set of one or more amounts of digital assets:
generating a signed command to transfer the each amount from the source wallet to the target wallet, the signed command having the each nonce and the each amount; and
storing the signed command without publishing the command to the blockchain; and
subsequent to the generating and storing the plurality of signed commands and in response to a trigger condition having been satisfied:
determining a new current nonce for the source wallet;
identifying an amount of digital assets to be transferred;
selecting from the stored signed commands a proper subset of the plurality of stored and signed commands having a sum total value substantially equal to the amount of digital assets to be transferred; and
publishing the selected signed commands to the blockchain.

11. The method of claim 10, further comprising, further in response to the trigger condition having been satisfied:
determining that the source wallet contains a digital asset balance at least as great as the amount of digital assets to be transferred.

12. The method of claim 10, wherein the source cryptographic wallet has an owner, and wherein the trigger condition is based on at least one of:
an expiration of a timer set or authorized by the owner,
a defined date or time set or authorized by the owner having been reached,
a recurring periodic duration set or authorized by the owner having elapsed,
a recurring or periodic transaction authorized by the owner having occurred,
an asset price threshold having reached a predefined level set by the owner, and
the owner having become deceased.

13. The method of claim 10, wherein the trigger condition is based on an action of an automated artificial intelligence agent acting on behalf of an owner of the source cryptographic wallet.

14. The method of claim 10, wherein the set of one or more amounts of digital assets consists of between 1 and 10 different amounts.

15. The method of claim 10, wherein the set of one or more amounts of digital assets consists of between 2 and 8 different amounts.

16. The method of claim 10, wherein the set of one or more amounts of digital assets consists of between 4 and 6 different amounts.

17. The method of claim 10, wherein the plurality of future nonces is a consecutive sequence, wherein a smallest of the plurality of future nonces is greater than the current nonce, and wherein the proper subset of the plurality of stored and signed commands further have a set of sequential nonces starting at one greater than the new current nonce.

18. A set of one or more computer systems that perform the method of claim 10.

19. A non-transitory computer readable medium having instructions stored thereon, wherein the instructions are executed by the one or more computer systems and cause the one or more computer systems to perform the method of claim 10.
